(19) United States
(12) Patent Application Publication
(10) Pub. No.: US 2019/0113093 A1
(43) Pub. Date: Apr. 18, 2019

(54) Wheat straw fiber brake friction material production process

(71) Applicant: JIANGSU JINMAISUI NEW ENERGY TECHNOLOGY CO,, LTD., Yandu District (CN)

(72) Inventor: Wanjun Xiong, Yancheng, Jiangsu (CN)

(21) Appl. No.: 16/090,183

(22) PCT Filed: Aug. 12, 2016
(86) PCT No.: PCT/CN2016/094933

§ 371 Date: Sep. 28, 2018

(30) Foreign Application Priority Data
Jun. 1, 2016 (CN) 201610384087.6

(51) Int. Cl. F16D 69/02; C09K 3/14; C08L 97/02

(52) U.S. Cl. CPC F16D 69/027; F16D 2200/006; C08L 97/02; C09K 3/149

(57) ABSTRACT

The present invention provides straw fiber brake friction material production process including wheat straw removal. After the impurities, cut into the first preset length of the broken straw, and the broken straw cooking fat after drying. The dried chopped straw first preset length cut into second preset length broken straw, the first preset length is larger than the second preset length; second preset crushed straw immersion length of the glue pool. Dipping 0.5-1.5 hours, the ingredients of high-speed mixer to stir for 20-40 minutes, until completely fusion. After the release of barrel formation of wheat straw fiber brake friction material. The embodiment of the invention of wheat straw fiber production process of car plate friction material has produced advantages for brake pad friction material low noise and good performance.

### CROSS REFERENCE OF RELATED APPLICATION

This is a U.S. National Stage under 35 U.S.C 371 of the International Application PCT/CN2016/094933, filed Aug. 12, 2016, which claims priority under 35 U.S.C. 119(a-d) to CN 201610384087.6, filed Jun. 1, 2016.

### BACKGROUND OF THE PRESENT INVENTION

### Field of Invention

The present invention relates to an automobile brake friction material production field, in particular to a wheat straw fiber production process of car plate friction material.

### Description of Related Arts

At present, the technology to produce automotive brake friction materials in continuous use, the brake noise larger, poor performance of the brake, the brake effect is not good.

Therefore, how to design a production process of brake pad friction materials to make produced brake pad friction materials with low noise and good braking performance is the urgent issue need to addressed.

### SUMMARY OF THE PRESENT INVENTION

In order to solve the problem of the existing technology, the invention provides a wheat straw fiber brake friction. Clean the material production process by adding wheat straw fiber in the production process to produce low noise and brake wheat straw fiber with good performance of brake friction materials.

The invention provides a wheat straw fiber brake friction material production process comprises the following steps:

The straw to remove impurities, cut into the first preset length of the broken straw, and the crushed straw cooking fat after drying;

The dried chopped straw first preset length cut into second preset length of stubble;

rod First, the default length of more than second preset length;

Second preset stubble length of the rod immersed in the glue pool dipping 0.5-1.5 hours, the glue pool. The mass percentage respectively: liquid resin 60%, Magnesium Oxide 10%, NBR rubber 5%,

The purity of more than 90 of the other 20% alcohol, catalyst 5%, plastic tank to control the temperature of 50-70 degrees celsius;

The dipping after second preset broken straw length and enhanced after drying, in accordance with the second preset length the crushed straw 35%, modified phenolic resin 7%, Building filler 19%, anti-friction material 20%, sulfur iron In 0.5%, carbon black 0.5%, alumina 1%, 40 mesh brass powder reinforced 7%. composite 10% phr the number of mixing and mixing machine to stir for 20-40 minutes at high speed to be completely released after fusion of barrel life. A wheat straw fiber brake friction material.

Preferably, the first preset length is less than 10 cm.

Preferably, the second preset length in 3-5 cm.

The crushed straw cooking fat after drying step, cooking time is controlled in 5 hours.

Preferably, the second preset stubble length of the rod immersed in the glue pool and dipped for 1 hours. The glue pool is to control the temperature of 60 degrees Celsius.

Preferably, in the dip after second preset stubble length and reinforced bar drying steps,

In the drying temperature control in 80-90 degrees Celsius.

Compared with the existing technology of wheat straw fiber, an embodiment of the present invention brake friction material production.

The art production of wheat straw fiber used in brake friction materials Wheat straw plant fiber products, organization frame. The dense, non pollution, green environmental protection material, used in brake friction materials, the temperature can be maintained. At 300 degrees Celsius, even more than you can bear the temperature of surface carbonization without coking, carbonized materials produced by friction material attached to the surface, lubrication friction like powder, unique fiber. Dimensional structure and coarse stalks can be dispersed outside of the brake friction material force is very good, play good. Good cushioning and rebound effect, can obtain immediately the braking effect, and does not damage the dual, reduce. Because of brake noise, the dispersion and binding to other materials uniformly excellent, greatly improved brake heat fade resistance and hardness.

### BRIEF DESCRIPTION OF THE DRAWINGS

FIG. 1 is a straw in a preferred embodiment of the present invention brake friction material production process block diagram.

### DETAILED DESCRIPTION OF THE PREFERRED EMBODIMENT

The description of drawings and specific implementation of further explanation of the invention.

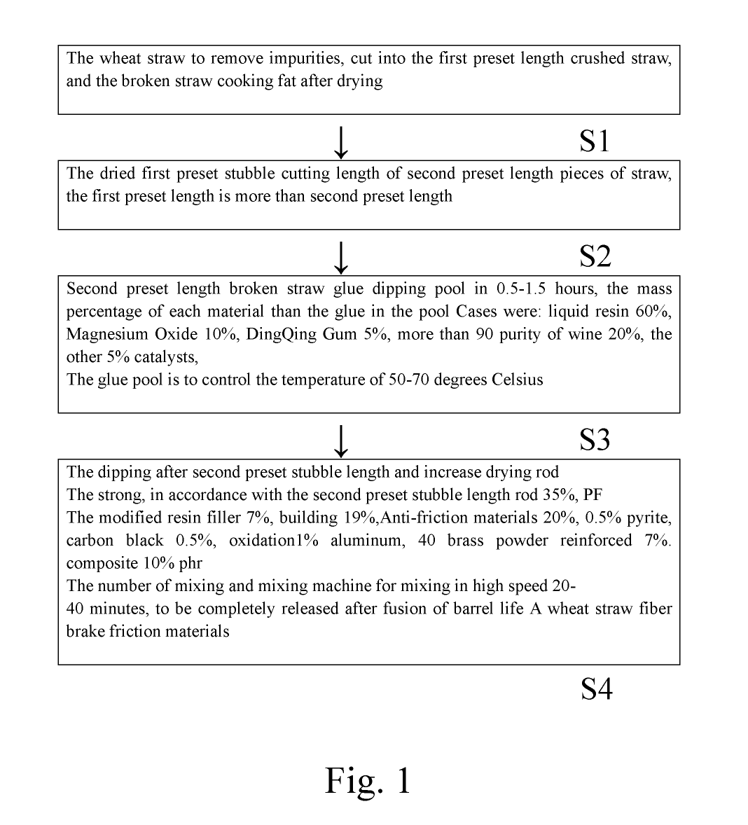

Please refer to FIG. 1. wheat straw fiber preferred embodiment of the present invention brake friction material production. Art includes the steps of:

S1: wheat straw to remove impurities, cut into the first preset length of the broken straw, and The broken Straw cooking fat after drying;

In this step, the wheat straw and dried to remove mud after root cutting, will cut the wheat straw.

A preset length, the first preset length is not greater than the length of the 10 cm, after drying in the process of cooking fat. Cooking time control in 5 hours.

The S2: will be dry after the first preset stubble rod length cut into second pieces of preset length

The orange bar, the first preset length is larger than the second preset length; In this step, second preset length in 3-5 cm.

S3: second preset stubble rod immersed in the glue pool length dipping 0.5-1.5 hours, the glue

The material in the pool quality percentage respectively: liquid resin 60%, Magnesium Oxide 10%, Ding Qingjiao 5%, the purity of more than 90 of the other 20% alcohol, catalyst 5%, plastic tank to control the temperature of 50-70 degrees Celsius Degree;

In this step, the second preset stubble length of the rod immersed in the glue pool dipping for 1 hours, and the glue pool under the temperature of 60 degrees Celsius.

S4: will be dipping Second preset stubble rod length and drying after enhancement, in accordance with the second preset the broken straw 35% length of the modified phenolic resin 7%, building filler 19%, anti-friction material 20%, from 0.5%, black 0.5%, alumina 1%, 40 mesh copper yellow 7%. enhanced material quality 10%. The amount of the number of copies of mixing and mixing machine to stir for 20-40 minutes at high speed to be completely released after fusion with 10 the barrel of wheat straw fiber formation of brake friction materials.

In this step, the dipping after second preset stubble length drying rod And enhanced step.

Suddenly, the drying temperature controlled at 80-90 degrees Celsius. The following products: product index index: Length: 1-2 mm diameter: 3-5 mm, the cellulose content is more than 50%, density: 1.35-1.72 g/cm3, Volatiles: less than 7%, the specific surface area: 0.05-0.08 m2/g, dry breaking strength greater than 1.75 cN/dtcx.

The S1 to S4 complete the wheat straw fiber brake friction material production, can be

By using the wheat straw fiber friction brake The production of brake friction materials, the specific process is as follows:

First of all, to provide steel back, and the back adhesive with good steel evenly coated steel back for pressing friction

The material on the surface. In this step, in accordance with the ratio of main materials added, including:

Steel back oil: will be back with the steel shot blasting machine to remove grease and rust;

With special glue glue: back to the working concentration with alcohol or acetone diluted steel;

Steel back glue: with prepared steel used glue evenly coated steel back for pressing friction material surface

Weigh the material: the material mixture is weighed according to the brake type and quantity needed.

Then, the The friction material fitted with steel back with hot pressing press generated semi-finished brake, hot pressing temperature is 150 DEG˜160 DEG, press pressure is 18 MPa, exhaust 3 time, each time for 30 seconds, holding 300 seconds;

Finally, after hot pressing the semi-finished brake heat treatment, heat treatment temperature for ladder type temperature of 150 DEG˜180 DEG, time is 4-12 hours, and then cooled to 50 DEG C, for machinery and accessories install straw fibre brakes. Including mechanical processing: according to the brake drawing process requirements 30 For grinding, chamfering and other mechanical processing; installation: the processing of the silencing sheet brake installed on the silencer. The attachment; rivet riveted on the brake pads steel back; spraying of brake mechanical dusting or painting; Printing: in the brake sheet spray model and production date;

Further, the wheat straw fiber brake package.

Compared with the existing technology of wheat straw fiber, an embodiment of the present invention brake friction material production. Art, production of wheat straw fiber brake friction material of this product is the use of wheat straw plant fiber, yield Product structure of dense, non pollution, green environmental protection material, used in brake friction materials, temperature can be maintained at 300 degrees Celsius, even more than you can bear the temperature of surface. Instead of coke, charcoal produced by the friction material attached to the surface, lubrication friction like powder, the fiber structure and coarse stalks unique can disperse outside of the brake friction material is very good force, play a good buffer and a rebound effect, can obtain immediately the braking effect, and no damage to dual, reduce the noise generated by the brake, dispersion and combination with excellent Other materials uniform distribution, improve brake heat fade resistance and hardness.

The above content is further said that the combination of specific preferred embodiment of the invention made. That cannot identify the specific embodiment of the invention, only limited to these instructions. The invention belongs to the technical. General technical personnel in the field, without departing from the inventive concept, can also be made if do the simple deduction or replacement, should be regarded as belonging to the scope of protection of the invention.

What is claimed is:

1. A method for producing a friction material for a straw stove fiber brake pad, comprising the steps of:
removing the impurity from the barley stem, cutting the first preset length of the shredded bar, and dividing the crumb rods are boiled and dried;
cutting the shredded first predetermined length of the shank bar into a second preset length of crumbs;
a first preset length greater than a second preset length;
the second preset length of the broken orange rod is immersed in the gel pool for 0.5-1.5 hours,
the percentage of mass percentage of each substance is: liquid resin glue 60%, magnesium oxide 10%, Dingqing plastic 5% purity of more than 90% of alcohol 20%, other catalyst 5%, the temperature of the gel pool at 50-70 degrees Celsius;
the second preset length of the shredded bar after drying is reinforced and reinforced, according to the second preset length 10;
35% of the shredded bar, 7% of the phenolic resin, 19% of the building filler, 20% of the friction material, 0.5% Pyrite, 0.5% carbon black, 1% alumina, 40 brass powder 7%, 10% by mass of the reinforcing material, the number of mixing and stirring in the high-speed mixer for 20-40 minutes, to be fully integrated after the release of barrels into the wheat straw fiber brake pads friction material.

2. The process for the production of the friction material for the wheat straw fiber brake pad according to claim 1, characterized in that And said first preset length is not greater than 10 cm.

3. The process for the production of the friction material for the wheat straw fiber brake pad according to claim 1, characterized in that and said second preset length is 3-5 cm,
in the step of drying the shredded bars and removing the fat, the time for cooking is controlled at 5 hours.

3. The process for the production of the wheat straw fiber brake pad according to claim 1, characterized in that said the second preset length of the shredded bars are immersed in a gel bath for 1 hour and the temperature of the gel tank is controlled at 60 degrees Celsius.

4. The process for the production of the wheat straw fiber brake pad according to claim 1, characterized in that, in the step of drying and enhancing the second preset length of the shredded bar after dipping, the drying temperature system at 80-90 degrees Celsius.
